(19) United States
(12) Patent Application Publication
(10) Pub. No.: US 2006/0099993 A1
(43) Pub. Date: May 11, 2006

(54) Multiple antenna portable hand-held electronic device

(75) Inventors: Marko E. Leinonen, Oulu (FI); Pertti Toivo Kangas, Oulu (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/982,469

(22) Filed: Nov. 5, 2004

(51) Int. Cl. H01Q 1/24

(52) U.S. Cl. 455/562.1

(57) ABSTRACT

A portable hand-held electronic device including a first section having electronic circuitry with a ground plane and a first antenna adapted to communicate with a mobile telephone system; and a second section movably connected to the first section. The second section includes a second frequency antenna. The second antenna is operably coupled to the electronic circuitry in the first section, and the second antenna is movable with the second section away from the ground plane as the second section is moved relative to the first section.

### BACKGROUND OF THE INVENTION

1. Field of the Invention

The present invention relates to a portable hand-held electronic device and, more particularly, to a cover having a movable section with an antenna.

2. Brief Description of Prior Developments

A current trend with portable hand-held mobile telephones is towards providing the telephones with metallic covers. Metallic covers makes antenna design very challenging since metallic covers act like a Faraday box. Thus, no radiation is going in or out from the terminal. With multimedia devices becoming more and more multifunctional in a radio communications perspective, new area(s) for the antennas are needed. Lower frequency radio signals need more distance from a ground plane of the device to work properly. These radio systems include, for example, AM-radio, FM-radio and DVB-H digital television signals. It has been studied several years to integrate an FM antenna inside of a mobile telephone, but with no success. When more distance is gained from a ground plane then the internal antenna performance is increased towards external FM-antenna performance. Currently, FM-radio reception in a multifunction mobile telephone device is done with an external antenna by using headset wires as an antenna.

The Nokia model 7700 Mobile Media Terminal, available from Nokia Corporation of Finland, provides mobile telephone features as well as Internet browsing and FM radio reception. In current Personal Digital Assistants (PDAs), movable protective covers are sometimes provided which do not have any other function other than to protect a display screen. Protective covers are widely used in PDA devices to protect expensive display units. This is one of the biggest risks in media devices; how to make display protection easily and cheaply.

### SUMMARY OF THE INVENTION

In accordance with one aspect of the present invention, a portable hand-held electronic device is provided including a first section having electronic circuitry with a ground plane and a first antenna adapted to communicate with a mobile telephone system; and a second section movably connected to the first section. The second section includes a second frequency antenna forming a non-cellular telephone antenna. The previously mentioned AM, FM and DVB systems are operating with lower frequencies than currently widely used cellular telephone systems. All other than cellular communication systems are considered as a non-cellular systems. Currently, the following non-cellular systems have been integrated into mobile terminals: GPS (Global Positioning System), Bluetooth connectivity, WLAN (Wireless Local Area Network) and new systems will be integrated in the future. The second antenna is operably coupled to the electronic circuitry in the first section, and the second antenna is movable with the second section away from the ground plane as the second section is moved relative to the first section.

In accordance with another aspect of the present invention, a protective cover for a portable hand-held electronic device is provided comprising a first cover section which is sized and shaped to cover at least a portion of the portable hand-held electronic device; a movable section adapted to move relative to the first cover section at a movable junction; a first non-cellular antenna connected to the movable section to move with the movable section; and a connection extending from the non-cellular antenna through the movable junction for connection to electronic circuitry in the portable hand-held electronic device. The non-cellular antenna is adapted to be moved away from the first cover section when the movable section is moved away from the first cover section to thereby move the non-cellular antenna away from a ground plane of the portable hand-held electronic device located inside the first cover section.

In accordance with one method of the present invention, a method of assembling a portable hand-held electronic device is provided comprising providing a main section of the portable hand-held electronic device with a first cellular mobile telephone antenna and a ground plane; providing a cover of the portable hand-held electronic device with a movable section having a second frequency non-cellular telephone antenna; and coupling the second antenna to electronic circuitry in the main section of the portable hand-held electronic device through a movable connection of the movable section to the main section, wherein the movable section is adapted to be moved away from the main section to move the second antenna away from the ground plane.

### BRIEF DESCRIPTION OF THE DRAWINGS

The foregoing aspects and other features of the present invention are explained in the following description, taken in connection with the accompanying drawings, wherein:

FIG. 1 is a front view of a portable hand-held electronic device;

FIG. 2 is a front view of the portable hand-held electronic device shown in FIG. 1 inserted into a protective cover forming one embodiment of the present invention;

FIG. 2A is a front view of an alternate embodiment of the invention shown in FIG. 2;

FIG. 3 is a perspective view of an alternate embodiment of the present invention;

FIG. 4 is a perspective view of another alternate embodiment of the present invention;

FIG. 5 is a perspective view of another alternate embodiment of the present invention shown in a closed position; and

FIG. 6 is a front view of the device shown in FIG. 5 in an open position.

### DETAILED DESCRIPTION OF THE PREFERRED EMBODIMENTS

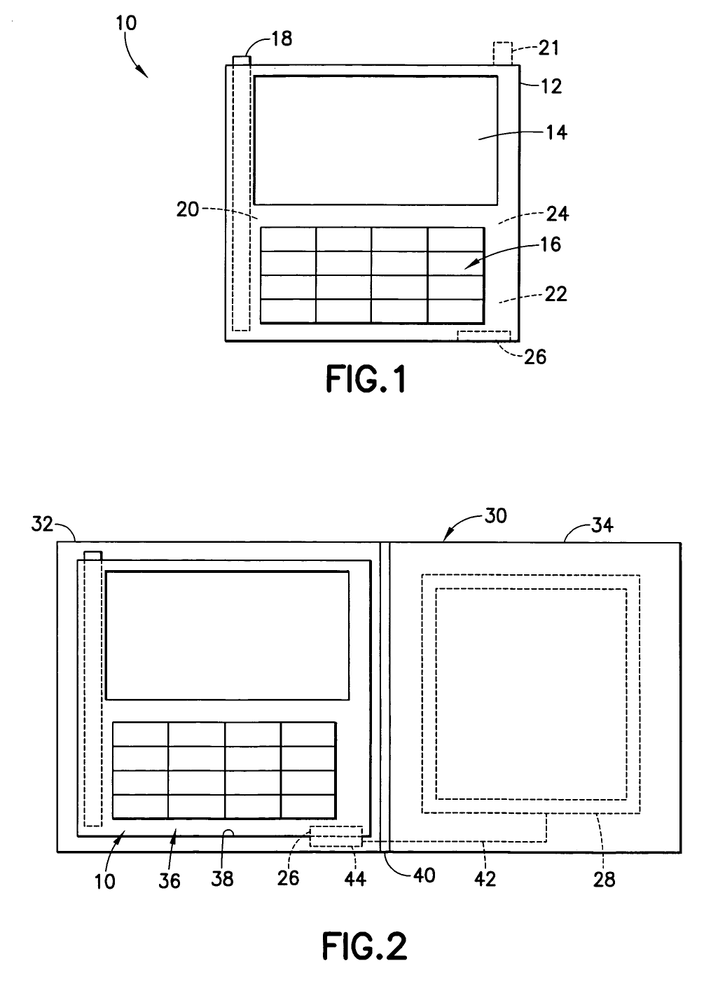

Referring to FIG. 1, there is shown a front view of a portable hand-held electronic device 10 incorporating features of the present invention. Although the present invention will be described with reference to the exemplary embodiments shown in the drawings, it should be understood that the present invention can be embodied in many alternate forms of embodiments. In addition, any suitable size, shape or type of elements or materials could be used.

In the embodiment shown in FIG. 1, the portable hand-held electronic device 10 comprises a mobile telephone. The mobile telephone comprises a housing 12, a display 14, input and control keys 16, a mobile telephone antenna 18 such as a cellular mobile telephone antenna, a transceiver 20, a battery 22, a controller 24 and an antenna connector 26. The device 10 can also comprise additional components conventional to mobile telephone terminals. The components of the mobile telephone form a first communications system. More specifically, the mobile telephone components are adapted to communicate with another telephone by means of a wireless telephone network system, such as a mobile telephone system with a wireless communications protocol such as GSM, WCDMA, CDMA, or TDMA, for example. The antenna 18 is tuned to an appropriate cellular or mobile telephone frequency range. For example, current mobile telephone frequencies include 800 MHz, 850 MHz, 1800 MHz, 1900 MHz, 2100 MHz standards in the AMPS, CDMA, TDMA, GSM, WCDMA, GPRS and EDGE standards and the proposed GSM and CDMA 450 Mhz and 480 Mhz ranges in Europe. Lower frequencies, on the other hand, can comprise FM radio transmissions in the range of about 88 Mhz-108 Mhz and VHF television transmissions in the range of about 30 Mhz-300 Mhz for example. The European DVB-H standard terminals will be operating at the frequencies from 470 MHz to 702 MHz. There might be a DVB-H system operating in the U.S., but the operational frequency will be around 1700 MHz. Thus, a mobile telephone antenna is not particularly suited or tuned for communications in these frequency bands.

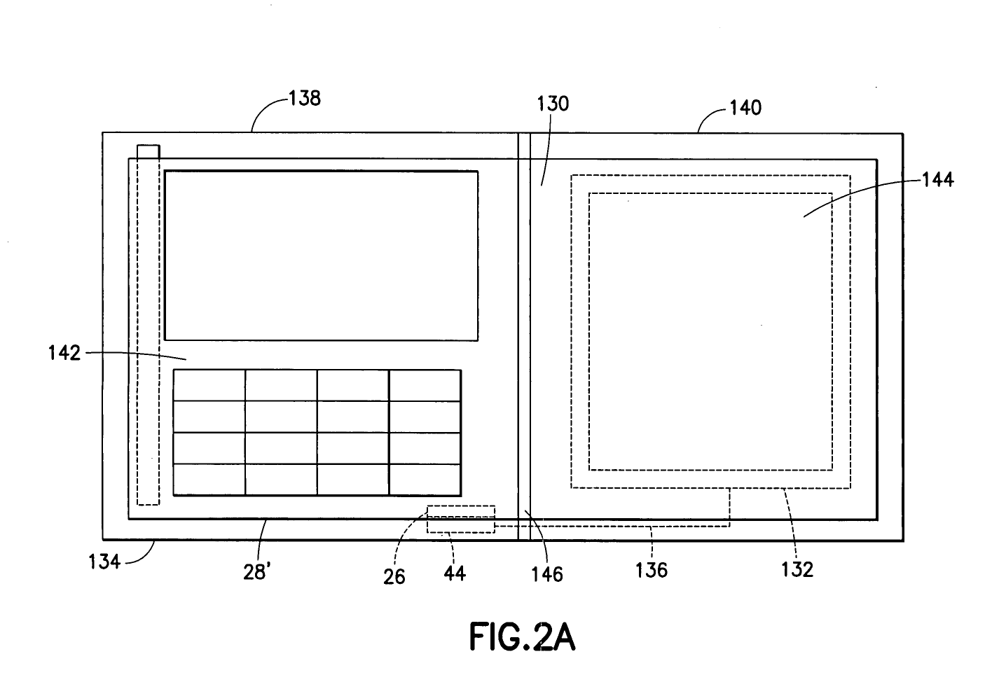

The device 10 preferably also comprises components for communication with at least one additional communications system. The additional communications system preferably communicates by a wireless link on a radio frequency which may operate with lower that the radio frequency used for the mobile telephone communications system. For example, the device 10 can comprise a Frequency Modulation (FM) radio receiver, and/or a Digital Video Broadcast (DVB) receiver, such as DVB-H or DVB-T receiver. As another example, the device could alternatively or additionally comprise a Radio Frequency Identification (RF-ID) system. The device 10 may also comprise an antenna 21 for sending and/or receiving communication signals in this additional communications system. In this case the signals can be combined from the antennas 21 and 28. The suitable signal combination can be done either as an antenna diversity combination or as an antenna selection. The antenna selection means that stronger antenna signal is selected. The antenna selection is used if the alternative antenna is not at place, or antenna 21 is used if there is no antenna 28. The diversity combination means that both antenna signals are used for future signal processing. The actual combination can be done with several criteria as a maximum ratio combining, direct summing, summing the power of the signals, etc. The mobile telephone antenna 18 is not adapted to send or receive the non-cellular frequency communication signals of the additional communications system. Instead, the antenna connector 26 is adapted to connect at least one second antenna 28 (see FIG. 2) to the components of the at least one additional communications system in the device 10.

Referring now also to FIG. 2, the device 10 is shown mounted in a cover 30. The cover 30 comprises a first cover section 32 and a second movable cover section 34. In the embodiment shown in FIG. 2, the second cover section 34 is shown in an open position. The cover 30 in this embodiment is an accessory for the device 10. The first cover section 32 comprises a receiving area 36 which is adapted to receive the device 10 therein. The receiving area 36 comprises an opening 38. With the device 10 positioned in the receiving area 36 the display 14 and the keys 16 are located in the opening 38 for access by a user. The first cover section 32 surrounds a majority of the exterior of the housing 12 except at the display 14 and input keys 16.

The second cover section 34 comprises a flap which is adapted to fold over the opening 38 at a rotatable or folding joint or junction 40 between the first and second cover sections 32, 34. Thus, the second cover section 34 can protect the display 14 and keys 16 when the second cover section is located in a closed, folded position over the first cover section 32. The second cover section 34, in addition to functioning as a protective cover for the display 14 and keys 16, also performs another function. In particular, the second cover section 34 comprises the second antenna 28. The second antenna 28 is a non-cellular antenna. Specifically, the second antenna 28 is tuned to communicate over a frequency different than the mobile telephone antenna 18, For example, the second antenna 28 could comprise an FM radio antenna, a DVB antenna, or an RF-ID antenna. In a preferred embodiment, the second antenna 28 comprises a flexible printed wiring board (FPWB), such as a flex cable. Flex cables, such as flexible flat conductor cable (FFC) or flexible printed circuit cable (FPC) are generally well known. The present invention can use a flex cable as the antenna 28. In an alternate embodiment, the antenna 28 could comprise an ordinary PWB which functions as the antenna rather than a flexible PWB. As another alternative, any suitable type of antenna could be used as the second antenna 28.

The cover 30 could be comprised of any suitable material such as fabric, leather, or a plastic or polymer member(s), or a combination of materials. The second antenna 28 is preferably inserted into the second cover section 34 or the second cover section can be formed over the second antenna 28. A connection 42 extends from the second antenna 28 to an electrical connector 44 in the first cover section 32. The connection 42 extends across the junction 40 and is adapted to bend without breaking when the second cover section 34 is moved relative to the first cover section 32 between its open and closed positions. The junction 40 could comprise a hinge and the connection 42 could be adapted to withstand the mechanical forces present during opening and closing of the hinge 40.

The connector 44 is adapted to connect to the antenna connector 26 of the device 10 when the device 10 is inserted into the receiving area 36. Thus, when the device 10 is inserted into the cover 30 the second antenna 28 is coupled with the electronics in the device 10. When the device 10 is inserted into the cover 30 the second antenna 28 combines with the electronic circuitry in the device 10 for sending and/or receiving communication signals with the second frequency additional communications system, such as receiving and playing FM radio broadcast signals and/or DVB television broadcast signals.

In one embodiment of the invention antenna 28 can operate with the same frequency as normal cellular antenna. However, it is a problem when two antennas are operating at the same frequency. If the antennas are too close to each other or there is not enough antenna isolation between the antennas, over all air interface performance is degraded. This is due to a phenomena where one antenna is transmitting a signal and second antenna in the same device is receiving a transmitted signal and feeding this signal to ground. No radiation is transmitted to the base station at all. It is advantageous that a diversity antenna is not close to another antenna operating at the same frequency.

In this case the antenna 28 can be used as a diversity antenna for cellular communications. This kind of diversity antenna for cellular communications is will be a cellular operator requirement. The diversity antenna increases the cell range. This way, less base stations are needed to cover a wider geographical area. When the diversity antenna is used, better sensitivity can be reached. This is advantageous for CDMA systems since terminal sensitivity has direct impact on how many users may talk at the same time. With better sensitivity, more users or better data rates for the users can be provided. The cellular signal from the antennas 18 and 28 can be combined in several ways. The easiest way is make an antenna selection based upon which antenna has the stronger signal.

Referring also to FIG. 2A an alternate embodiment of the present invention is shown. In this embodiment the assembly comprises a portable hand held electronic device 130 and a removable cover 134. The device 130 has a first section 142 and a second section 144. The second section 144 is movable or pivotable relative to the first section 142 at a junction 146. In this embodiment the portable hand held electronic device 130 comprises a first part 132 of the second antenna 28′ and the cover 134 comprises a second part 136 of the second antenna 28′. Section 140 of the device/cover combination 130, 134 can be moved between open and closed positions relative to the section 138 of the device/cover combination 130, 134. Antenna functionality can be shared between device 130 and the cover 134. This sharing of the antenna functionality makes lower frequency antennas more feasible since available volume and size for a longer wavelength antenna is increased.

Referring now to FIG. 3, an alternate embodiment of the present invention is shown. In this embodiment of the assembly 46 generally comprises a portable hand-held electronic device 48 and a protective cover 50. The device 48 comprises a relatively large display 52 and control buttons 54. Device 48 preferably comprises a mobile telephone communications feature and includes a mobile telephone antenna and transceiver similar to that described above with reference to FIGS. 1 and 2. The device 48 could comprise a personal digital assistant (PDA) or any suitable type of mobile communicator including a gaming device comprising a mobile telephone communications feature.

The protective cover 50 generally comprises a fabric and or leather cover with a first section 56 and a second section 58. The first section 56 substantially surrounds the device 48 with suitable openings for the user to see the display 52 and access the control buttons 54. The second section 58 comprises a flap attached to the top back side of the first section 56. FIG. 3 shows the flap 58 in an open position. The flap 58 is adapted to bend at the section 60 such that the flap 58 can close over the display 52 and control buttons 54 to protect the display and control buttons.

In this embodiment, the second section 58 comprises pockets which can be used to hold items such as credit cards 62. However, in an alternate embodiment, the pockets need not be provided. The second section 58 also comprises a second antenna 64. The second antenna 64 is a non-cellular antenna. Specifically, the second antenna 64 is tuned to communicate over other frequency than the mobile telephone antenna in the device 48. For example, the second antenna 64 could comprise a FM radio antenna, a DVB television antenna, or an RF-ID antenna. In a preferred embodiment, the second antenna 64 comprises a flexible printed wiring board (PWB), such as a flex cable. The protective cover 50 comprises an antenna connector 66 which connects the second antenna 64 to the electronic circuitry in the device 48 when the device is inserted into the receiving area of the first section 56. The second antenna 64 could be provided to supplement or switch from a smaller, non-cellular frequency antenna already existing in the device 48.

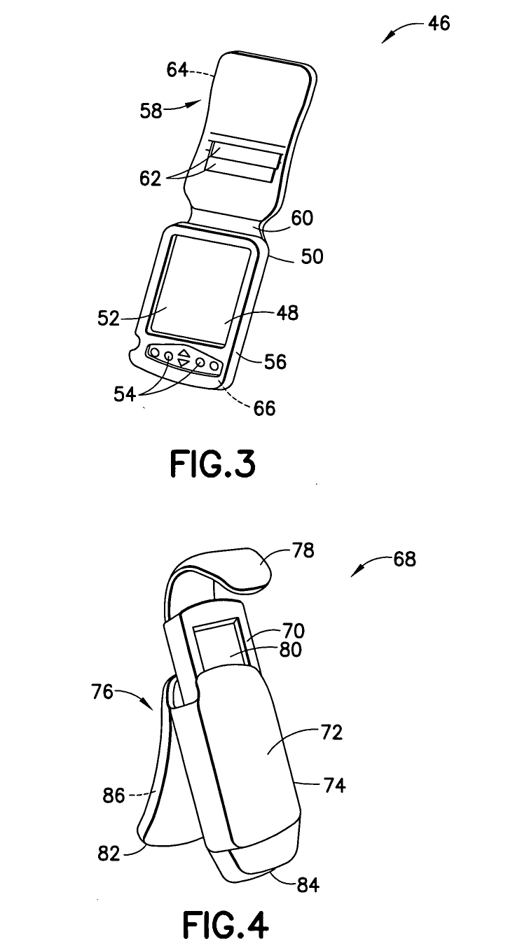

Referring now to FIG. 4, another alternate embodiment of the present invention is shown. In this embodiment the assembly 68 comprises a portable hand-held electronic device 70 and a protective cover 72. The cover 72 comprises a first section 74, a second section 76 and a flap 78. The device 70 is inserted through the open top of the first section 74. Device 70 comprises a display 80 which can be viewed by a user when the flap 78 is in an open position. The flag 78 can be closed over the display 80 to protect the display. The second section 76 is pivotably attached to the first section 74 at a rear side of the first section. The second section 76 forms a desk stand for the cover 72. When the second section 76 is in an open position as shown in FIG. 4, the bottom 82 of the second section 76 and the bottom 84 of the first section 74 can be stablely located on a flat surface such that the display 80 is at least partially in an upright or vertical position for viewing by a user.

The second section 76 in addition to forming a desk stand for the protective cover also comprises a second antenna 86. The second antenna 86 is a non-cellular antenna. Specifically, the second antenna 86 is tuned to communicate over another frequency different than the mobile telephone antenna in the device 70 (i.e., lower than 450 Mhz for example). For example, the second antenna 86 could comprise a FM radio antenna, a DVB television antenna, or an RF-ID antenna. The device 70 comprises an electrical connector which is connected to the second antenna 86 when the device 70 is inserted into the first section 74. The device 70 comprises a metal housing. Thus, location of the second antenna 86 outside of the metal housing allows better reception by the antenna. The metal housing also forms a portion of a ground plane for the device 70. Thus, movement of the second section 76 to its open position moves the second antenna 86 away from the ground plane of the device 70 for better reception and/or transmission of lower frequency signals (i.e., below 450 Mhz for example). In another embodiment, the second antenna 86 could be located in the flap 78. In other embodiment the flap 78 could include the second antenna 86 and the flap 78 could be opened to the position of the second section 76 shown in the figure. In this case, the second section 76 could be the same part as the flap 78 which can be moved from a display protection position to a desk stand position.

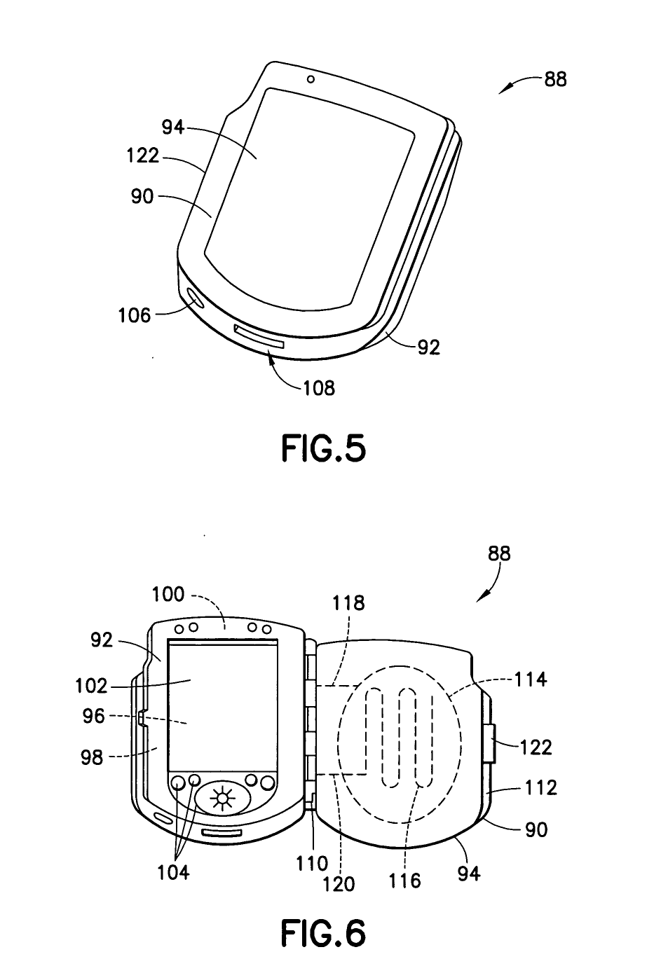

Referring now to FIGS. 5-6, an alternate embodiment of the present invention is shown. In this embodiment, a portable hand-held electronic device 88 is provided with an integrated protective cover 90. Device 88 comprises a first section 92 and a second section 94. The first section 92 comprises electronic circuitry 96 with a ground plane 98 and a first antenna 100 adapted to communicate with a mobile telephone system. The first section 92 includes a display 102 and control buttons 104. The first section 92 also comprises a power connector 106 and an auxiliary antenna connector 108. The power connector 106 allows a power adapter to be connected to the device 88 such that the device 88 can be operated without using its battery. The antenna connector 108 allows and auxiliary antenna, such as an antenna on a headset (not shown), to be attached to the device 88. The antenna 100 comprises a mobile telephone antenna attenuated or tuned to communicate over higher radio frequencies, such as 450 Mhz, 800 Mhz, 900 Mhz, 1800 Mhz, or 1900 Mhz mobile telephone standards for example. The first section 92 could comprise more than one mobile telephone antenna.

The second section 94 is pivotably connected to the first section 92 by a hinge system 110. The second section 94 comprises a housing 112 preferably comprised of a molded plastic or polymer material. In this embodiment, the second section 94 comprises two antennas 114, 116 therein. The antennas 114, 116 are attenuated or tuned to frequencies lower than the mobile telephone frequencies of the antenna 100. In a preferred embodiment, the antennas 114, 116 are also attenuated or tuned to two frequencies which are different from each other. For example, the antenna 114 could be tuned to FM radio broadcast frequencies and the antenna 116 could be tuned to DVB television frequencies. The antennas 114, 116 are connected to the electronic circuitry 96 in the first section 92 by connections 118, 120 which through the hinge system 110.

FIG. 5 shows the device 88 with the cover 90 in a closed position. The second section 94 is located over the top of the first section 92 to protect the display 102 and control buttons 104. The device 88 preferably comprises a latch 122 to keep the cover 90 in this closed position until desired to be opened by a user. FIG. 6 shows the device 88 with the cover 90 moved to the open position. When the cover 90 is moved to the open position, the antennas 114, 116 located in the second section 94 are moved away from the ground plane 98 in the first section 92. This allows for better reception by the antennas 114, 116 for their tuned frequency ranges. By locating the antennas 114, 116 in the second section 94, the second section 94 allows for more area for the antennas to occupy and, thus, the antennas 114, 116 can be larger than could otherwise be provided in the footprint of the first section 92. The cover 90 in addition to functioning as a protector for the display 102 and control buttons 104 provides the additional function of an antenna which is automatically moved away from the ground plane in the first section 92 when the user opens the device 88 for viewing the display. This is particularly advantageous when the antennas 114, 116 are lower frequency range antennas as noted above. By moving the lower frequency range antennas 114, 116 away from the ground plane, reception of lower frequency signals by the antennas 114, 116 is improved. This can be particularly advantageous if the housing of the first section 92 is comprised of metal or is part of the ground plane 98.

The can comprise placing a non-cellular antenna(s) with a protective cover to a display. The protective cover can be made from non-metallic material (i.e., fabric, leather, plastics or polymer material) and the antenna itself can be made as a flexible Printed Wiring Board (PWB), such as a flex cable, or as normal PWB.

The invention can comprise placing one or more non-cellular antennas into the protective cover for a display. This kind of protective cover can be used in a PDA device to protect an expensive display unit. The idea of the invention can be embodied by integrating one or more antennas with a protective flap. It is advantageous to make the antenna protective cover open such as by a flap movement to create more distance to the ground plane of the mobile terminal. This is needed especially in digital TV reception (Digital Video Broadcast; DVB-T or DVB-H) since in future expected products antenna performance for digital TV will be needed to be improved.

The non-cellular antenna can be in a credit card flap, but this might not be desirable since credit cards may degrade antenna performance. When the non-cellular antenna design opening is done smartly, then the non-cellular antenna can be used for other purposes, such as a desk stand of the device in TV usage. This can improve TV reception. This way the non-cellular antenna can be moved far from the terminal ground plane.

According to one aspect of the invention, the opening part of a cover is an antenna part, and several antennas can be integrated to this section of the device. Examples of most probably non-cellular antennas are FM-radio, DVB-H and Radio Frequency Identification (RF-ID) antennas which can be placed to this section of the product. The antenna feeding signals need to be routed to and/or from the flap part, such as similar to signal routing done in the Nokia Communicator products sold by Nokia Corporation or other clam shell type mobile telephone or expandable/collapsible type electronic device having a mobile phone capability. A bottom connector can also be provided which can be used as a connector for an external FM-antenna (such as a headset antenna).

With the present invention, the protective cover has more functions than just an extra moving part. More antenna area is provided in a movable cover section for the antenna and, more importantly, the lower frequency antenna(s) can be moved away from the ground plane of the mobile telephone terminal. The protective cover can be designed as a desk stand which provides a good position for digital TV reception. Signals to and from the antenna cover are preferably routed via a hinge system. With the present invention a shared antenna functionality can be provided between an antenna of the device and the antenna in the openable part (such as a cover or an openable part of the device). Cellular telephone antenna diversity can be provided with multiple antennas in a single device or a device and cover combination. Features of the present invention (namely a second different frequency antenna in a movable part such as a cover for example) could also be used with other non-cellular connections, such as GPS, WLAN and Bluetooth for example.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A portable hand-held electronic device comprising:
a first section having electronic circuitry with a ground plane and a first antenna adapted to communicate with a mobile telephone system; and
a second section movably connected to the first section, the second section comprising a second antenna, wherein the second antenna is operably coupled to the electronic circuitry in the first section, and wherein the second antenna is movable with the second section away from the ground plane as the second section is moved relative to the first section.

2. A portable hand-held electronic device as in claim 1 wherein the first section comprises a mobile telephone.

3. A portable hand-held electronic device as in claim 2 wherein the ground plane comprises a metallic housing of the mobile telephone or a printed wired board of the mobile telephone.

4. A portable hand-held electronic device as in claim 1 wherein the second section is pivotably connected to the first section.

5. A portable hand-held electronic device as in claim 1 wherein the second section comprises a cover with a substantially stationary cover section at least partially enclosing the first section of the portable hand-held electronic device and a second movable cover section adapted to move relative to the first cover section, and
wherein the second antenna is located in the second movable cover section.

6. A portable hand-held electronic device as in claim 5 wherein the second movable cover section is adapted to cover over a display of the first section of the portable hand-held electronic device.

7. A portable hand-held electronic device as in claim 5 wherein the second movable cover section comprises a flap.

8. A portable hand-held electronic device as in claim 1 wherein the second movable cover section comprises a desk stand.

9. A portable hand-held electronic device as in claim 1 wherein the second section comprises a non-metallic frame.

10. A portable hand-held electronic device as in claim 9 wherein the non-metallic frame comprises leather.

11. A portable hand-held electronic device as in claim 9 wherein the non-metallic frame comprises a molded plastic or polymer member.

12. A portable hand-held electronic device as in claim 1 wherein the second section comprises multiple antennas.

13. A portable hand-held electronic device as in claim 1 wherein the second section comprises a flap which is adapted to cover over a display of the first section of the portable hand-held electronic device, and wherein the second section comprises a third antenna having a tuned communication frequency different from the first antenna and the second antenna.

14. A portable hand-held electronic device as in claim 1 wherein the second antenna comprises a tuned communication frequency for receiving Amplitude Modulated (AM) radio signals, or Frequency Modulated (FM) radio signals or Digital Video Broadcast (DVB) signals or Radio Frequency Identification (RF-ID) signals or Global Positioning System (GPS) signals, or Bluetooth connectivity signals, or Wireless Local Area Network (WLAN) signals.

15. A portable hand-held electronic device as in claim 1 wherein the second section comprises a second part of the second antenna and the first section comprises a first part of the second antenna.

16. A portable hand-held electronic device as in claim 1 wherein the second antenna is tuned to a different frequency than the first antenna.

17. A portable hand-held electronic device as in claim 16 wherein the second antenna is turned to a non-cellular frequency.

18. A portable hand-held electronic device as in claim 1 wherein the second antenna is tuned to a same frequency as the first antenna.

19. A portable hand-held electronic device as in claim 18 wherein the second antenna is tuned to a cellular frequency.

20. A portable hand-held electronic device as in claim 18 wherein the second antenna is a cellular diversity antenna.

21. A portable hand-held electronic device as in claim 1 wherein the second antenna is tuned to a same frequency as a third antenna in the first section.

22. A portable hand-held electronic device as in claim 21 wherein the second antenna is a non-cellular frequency diversity antenna.

23. A portable hand-held electronic device as in claim 1 wherein a part of the second antenna is included inside of the first section.

24. A protective cover for a portable hand-held electronic device comprising:
a first cover section which is sized and shaped to cover at least a portion of the portable hand-held electronic device;
a movable section adapted to move relative to the first cover section at a movable junction;
an antenna connected to the movable section to move with the movable section; and
a connection extending from the antenna through the movable junction for connection to electronic circuitry in the portable hand-held electronic device, wherein the antenna is adapted to be moved away from the first cover section when the movable section is moved away from the first cover section to thereby move the antenna away from a ground plane of the portable hand-held electronic device located inside the first cover section.

25. A protective cover for a portable hand-held electronic device as in claim 24 wherein the first cover section and the movable section are comprises of fabric or leather.

26. A protective cover for a portable hand-held electronic device as in claim 24 wherein the first cover section forms a portion of a housing of the portable hand-held electronic device.

27. A protective cover for a portable hand-held electronic device as in claim 24 wherein the movable section comprises a flap to cover a display of the portable hand-held electronic device located inside the first cover section.

28. A protective cover for a portable hand-held electronic device as in claim 24 wherein the movable section is pivotably connected to the first cover section.

29. A protective cover for a portable hand-held electronic device as in claim 24 wherein the movable section comprises a desk stand.

30. A protective cover for a portable hand-held electronic device as in claim 24 further comprising a third antenna located in the movable section and having a tuned communication frequency different from the antenna connected to the movable section.

31. A protective cover for a portable hand-held electronic device as in claim 24 wherein the non-cellular antenna comprises an attenuated communication frequency for receiving Frequency Modulated (FM) radio signals or Digital Video Broadcast (DVB) signals.

32. A protective cover for a portable hand-held electronic device as in claim 24 wherein the antenna is tuned to a same frequency as another antenna of the portable hand-held electronic device as a diversity antenna.

33. A protective cover for a portable hand-held electronic device as in claim 24 wherein the antenna is tuned to a same frequency as another antenna different from a frequency of a cellular antenna inside in the first section.

34. A protective cover for a portable hand-held electronic device as in claim 24 wherein a part of the antenna is included inside of the first section.

35. A method of assembling a portable hand-held electronic device comprising:
providing a main section of the portable hand-held electronic device with a first cellular mobile telephone antenna and a ground plane;
providing a cover of the portable hand-held electronic device with a movable section having a second frequency antenna; and
coupling the second antenna to electronic circuitry in the main section of the portable hand-held electronic device through a movable connection of the movable section to the main section, wherein the movable section is adapted to be moved away from the main section to move the second antenna away from the ground plane.

36. A method as in claim 35 wherein the ground plane comprises a metallic housing member of the portable hand-held electronic device or printed wired board of the first section, and the method further comprises moving the cover relative to the metallic housing member to move the second antenna in a direction away from the metallic housing member.
